(19) United States
(12) Patent Application Publication
(10) Pub. No.: US 2016/0321959 A1
(43) Pub. Date: Nov. 3, 2016

(54) IDENTIFICATION DEVICE

(71) Applicant: WAX SEAL LIMITED, Birmingham (GB)

(72) Inventor: Andreas Sotiriou Constantinou, Solihull (GB)

(73) Assignee: Wax Seal Limited, Birmingham (GB)

(21) Appl. No.: 15/103,232

(22) PCT Filed: Dec. 9, 2014
(86) PCT No.: PCT/GB2014/053638

§ 371 Date: Jun. 9, 2016

(30) Foreign Application Priority Data
Dec. 10, 2013 (GB) 1321843.3

(51) Int. Cl. G09F 3/00; G09F 3/10

(52) U.S. Cl. CPC G09F 3/0294; G09F 3/10

(57) ABSTRACT

An identification device comprises a support layer which comprises one or more markings and a contrast agent. The contrast agent is transformable upon application or removal of non-visible radiation between a first optical state and a second optical state. The first optical state provides a low contrast with said markings and the second optical state provides a high contrast with said markings.

### FIELD OF THE INVENTION

The present invention relates to an identification device with variable contrast. More specifically, the present invention relates to devices and methods allowing the contrast of an identification device to be modified in a temporary and/or reversible manner, in order to improve the legibility or discernibility of features shown on the identification device.

### BACKGROUND

Identification devices, in the form of labels, stickers, adhesive layers, or the like, are widely used to convey product information about a product with which an identification device is associated. The product information may comprise one or more of an identity of a product, a composition of a product, an origin of a product, safety information, instructions, or general information about a product.

It is often desirable that an identification device is unobtrusive, to avoid that the presentation of a product to which the identification device is applied is adversely affected. In other words, there is a desire to reduce the surface area that is concealed by the identification device.

However, identification devices may need to display a large amount of information or detailed features, so that features can easily be discerned, and so that any information displayed is legible or machine-readable.

Thus, there is to some extent a tradeoff between the aim of providing an unobtrusive identification device and the aim of providing a high level of discernibility and/or legibility.

The present invention has been devised to alleviate the above-described tradeoff.

### SUMMARY OF THE INVENTION

In accordance with the present invention, there is provided an identification device comprising a support layer comprising one or more markings and a contrast agent transformable upon application or removal of non-visible radiation between a first optical state that provides a low contrast with said markings and a second optical state that provides a high contrast with said markings.

The identification device may be a label, a tag, a sticker, or similar device. The support layer may be provided in the form of a film or sheet of polymeric material, such as polyethylene, polypropylene, polyvinyl chloride, BoPET, or other suitable substrates. It is understood that the support layer is generally planar and has a thickness which can be in the region of a few micrometres (μm), e.g. 1 μm, 5 μm, 10 μm, 15 μm, or thicker. The support layer has a first surface and a second surface opposite the first surface.

It will be understood that the markings on or in the support layer are less visible when the contrast agent provides low contrast, and that the markings have a better visibility, so as to be readily discernible, when the contrast agent provides a high contrast. By “visible”, it is meant that a feature can be inspected by eye in normal/daylight conditions.

For instance, the markings could be provided in the form of a text printed in a light colour tone against a light-coloured support layer. Upon transformation of the contrast agent into the high contrast state, the contrast agent may darken the support layer, so that the light-coloured text becomes more visible.

By “non-visible radiation”, wavebands of the electromagnetic spectrum are meant that are not visible to the human eye. The visible part of the spectrum is usually understood to be the range from about 380 nm to about 780 nm. Thus, the expression non-visible radiation includes ultraviolet radiation that is below about 380-400 nm. In particular, the non-visible radiation that is suitable to transform the contrast agent from a first optical state to a second optical state might be referred to as “contrast-changing” radiation.

In one embodiment, the support layer is, in absence of a contrast agent, at least partially transparent. By “at least partially transparent”, it is meant that a proportion of the light impinging onto one of the surfaces of the support layer is transmitted through the support layer without being absorbed or reflected.

The proportion of light transmitted may be at least 30%, 40%, or may be a majority of the visible light. By “majority of the visible light”, at least 50%, 60%, 70%, or 80% is meant.

However, it will be appreciated that, for practical purposes, the support layer, even if transparent, may still absorb or reflect some visible light. Thus, the support layer, even without the contrast agent, may appear slightly tinted or coloured, but it will permit light to be transmitted, thereby allowing a person to look through the support layer or read information beneath the support layer.

It will be appreciated that in embodiments with an at least partially transparent support layer, the low-contrast state of the contrast agent is preferably semi-transparent or transparent. As such, in the low-contrast condition, the visibility of the one or more markings against the support layer is not affected by the contrast agent.

When the contrast agent exhibits high contrast, the support layer may be more opaque. As such, in the high-contrast condition, the visibility of the one or more markings against the support layer is improved. At the same time, when the contrast agent renders the support layer opaque, a surface beneath the identification device cannot be readily inspected through the identification device.

For instance, the contrast of the identification device may be improved simply by providing a homogenous background against which the one or more markings can be inspected.

It will be appreciated that, in embodiments with an at least partially transparent support layer, the contrast agent may predominantly be in the second optical state, and transform to the first optical state upon application or removal of the radiation, or, vice versa, the contrast agent may predominantly in the first optical state, and transform to the second optical state upon application or removal of the radiation.

In an embodiment, the contrast agent is a photochromic substance.

Photochromic substances are a group of materials that alter their optical properties in response to electromagnetic radiation applied to them. An example of photochromic substances are optical glasses that darken when exposed to sun-light, thereby converting to optical shades. The exact behaviour of photochromic substances can be tailored, so as to change between a first colour and a second colour, or between an opaque state and a transparent state. It will be appreciated that the level of transparency, or the saturation of a colour, can be tailored. Likewise, the activation wavelength can be tailored. The photochromic substance may be a photochromic dye.

Photochromic dyes may be provided by a variety of methods. Photochromic dyes can be contained in, and/or coated onto, impregnated within, applied to, or otherwise combined with aqueous or non-aqueous substrates. Suitable substrates include gels, gel precursors, adhesives, lacquers/varnishes, liquids, paints, resins, plastics, photopolymers, photothermoplastics, photographic emulsions, dichromated gelatine, photoresists, photorefractives, substrates, films, foils, glass, ceramics, pearlescent materials, iridescent materials, opalescent materials and combinations thereof.

In an embodiment, the contrast agent is responsive to ultraviolet (UV) light, such that UV light causes the transition between the low-contrast state and the high-contrast state.

The inventor found that a contrast agent, such as a photochromic substance, that can be activated by ultraviolet (UV) radiation, i.e., light having a wavelength of less than 400 nm, 380 nm, 350 nm, 330 nm, 300 nm, 280 nm, or 250 nm, is particularly suitable for identification devices of embodiments of the invention. Furthermore, if it is intended to provide machine-readable markings, it is desirable that the responsiveness of the contrast agent is chosen such that it is not negatively affected by any radiation emitted as part of the machine-reading process.

By using a UV-activatable photochromic substance as the contrast agent, the contrast of the identification device may be altered by purposeful activation using a readily available UV flash light. Also, the spectrum of normal daylight (sun light) does contain UV components in addition to the visible parts of the spectrum.

Thus, embodiments of the invention allow a contrast agent to be provided that is in an activated, high-contrast state while it is exposed to daylight. In situations where products carrying the identification device are on display, e.g. for sale, and exposed to high levels of daylight, the display cabinets may be made of transparent UV-blocking materials to prevent undesired and/or inadvertent activation of the identification devices.

On the other hand, infra-red (IR) or heat radiation may be undesirable, because the contrast of the identification device may change inadvertently.

In an embodiment, the contrast agent is configured to allow a reversible transformation between the first optical state and the second optical state.

By “reversible” it is meant that the contrast agent may undergo a transformation from one optical state to the other optical state without a noticeable change of the contrast quality.

For instance, the contrast agent may change from the low-contrast state, exhibiting a first level of transparency, to the high-contrast state, exhibiting a second level of transparency that is lower than the first level, and then back from the high-contrast state to the low-contrast state, again exhibiting the first level of transparency without a noticeable diminishing of the transparency.

In an embodiment, the contrast agent is configured to allow a repeated reversible transformation between the first optical state and the second optical state.

By “repeated reversible conversion” it is meant that the contrast may be changed multiple times without noticeably reducing the strength of the high contrast, or without noticeably increasing the low contrast to a higher level.

In an embodiment, the transformation between the first optical state and the second optical state is temporary.

By “temporary” it is meant that the change from one contrast state to the other contrast state lasts for a limited duration of time. For instance, the contrast agent may exhibit low contrast, unless it is exposed to the non-visible radiation.

It is understood that the change of contrast is gradual, but may happen very quickly. In response to the contrast-changing radiation, such as UV irradiation, the contrast agent changes its state to exhibit a high contrast. This change may occur within 0.1, 0.2, 0.3, 0.4, 0.5, 0.6, 0.7, 0.8, 0.9, 1, 2, 3, 4, or 5 seconds, until the high contrast reaches is maximum. The high contrast may be exhibited while the contrast-changing radiation continues to shine onto the contrast agent. Once the contrast-changing radiation ceases, the high contrast may near the maximum for a limited time, such as 5, 10, 15, 20, 25, 30, 35, 40, 45, 50, 55, 60, 90, 120, 240, 300, or 360 seconds, until the contrast fades to the low contrast level, and the discernibility of the one or more markings gradually decreases.

One embodiment of the invention may comprise a plurality of contrast agents including a first contrast agent and a second contrast agent, wherein the first contrast agent exhibits a response behaviour to the contrast-changing radiation that is different from the response behaviour of the second contrast agent.

A combination of photochromic dyes having different activation properties may be used in a single identification device. For instance, an identification device may comprise a first contrast agent having a first activation rate and a first fade rate, and a second contrast agent having a second activation rate and a second fade rate. Preferably, the first contrast agent has a different colour than the second contrast agent. Assuming that the first activation rate and the first fade rate is faster than the corresponding second rates, the contrast of the contrast agents will change sequentially, thus providing a two-colour contrast. The “response behaviour to the contrast-changing radiation” may be defined by the activation rate, and/or by the fade rate.

To illustrate this with an example, the first contrast agent may appear red when exhibiting high contrast, with an activation rate of 0.1 seconds and a fade rate of 30 seconds. The second contrast agent may appear blue when exhibiting high contrast, with an activation rate of 5 seconds and a fade rate of 2 minutes. When activated, the one or more markings would first turn from transparent to red, may then appear purple, as the red contrast agent fades to its low-contrast condition, and then appear blue until the blue contrast agent fades to its low-contrast condition.

It will be appreciated that the exact duration of time is determined by the composition of the contrast agent. For practical purposes, the contrast agent will be designed in such a manner that the desired contrast can be activated quickly, and such that the desired contrast remains for a time that is suitable for inspection of the identification device. The time may depend on the size of the one or more markings and on the amount and detail of information presented in the one or more markings.

In embodiments comprising a plurality of contrast agents, at least one of the one or more markings may comprise a contrast agent.

In an embodiment, the one or more markings comprise an optical machine-readable pattern.

Optical machine-readable patterns are patterns encoding information that can be scanned and decoded by a machine reader. Examples of optical machine-readable patterns are a barcode, OR code, or similar feature.

The markings may show or encode information about the identity of a product, a composition of a product, an origin of a product, safety information, instructions, general information about a product, or a combination thereof.

By “showing” it is meant that the markings are legible upon visual inspection, provided that there is sufficient contrast. By “encoding” it is meant that the markings show features that can be scanned or discerned upon visual inspection, but that need to be decoded to render the information content contained therein intelligible.

In an embodiment, the one or more markings comprise an optically variable feature.

The inventor found that, surprisingly, the provision of a contrast agent improves the legibility not only of text matter, but also the discernibility of optically variable features. Optically variable features are devices exhibiting varying visual effects, such colour changes, depending on the viewing conditions, such as the viewing angle. Thus, optically variable devices cannot easily be reproduced by photocopying.

Optical variable features include photopolymer holograms, HRI (high refractive index) holograms, micro embossed holograms, transparent foils, watermarks, and others, with holograms being a prominent example of an optically variable device. Optically variable devices are used for a large variety of purposes, such as decoration, marking, or as anti-counterfeit device.

As such, it is understood that at least one of the one or more markings of the invention may be provided in the form of an optically variable feature. The one or more markings may show an optical machine-readable pattern, such as a barcode or a OR code, or a logo, text matter, number combination, or combinations thereof.

In an embodiment, the one or more markings comprise one or more of a security feature or an anti-counterfeit feature.

Anti-counterfeit labels are often desired by a manufacturer or distributor of a product. However, end-users may not dedicate much consideration to the presence of an anti-counterfeit label if this negatively affects the appearance of a product. Furthermore, in some cases, it is not possible to provide a suitably effective anti-counterfeit label without negatively affecting the legibility or prominent display of other markings that are required by law.

For instance, batteries may have to be provided with safety information that must be printed on a side of the battery that is visible when the battery is inserted in an electronic device. With the increasingly reduced size of electronic devices, it can be a challenge to find enough space, or “real-estate”, for an anti-counterfeit label in addition to the legally required safety information, particularly as safety information may have to be provided in multiple languages. The same problem is prevalent with medicament packaging, medical utilities, FMCG, and many other products.

Likewise, it is possible to manufacture optically variable features that are transparent or semi-transparent when seen from one angle, but show detailed features when held against a background providing suitable contrast. By “semi-transparent” it is meant that by visual inspection it can be seen that a feature is present, but the feature is not readily discernible.

For instance, a semi-transparent hologram may appear as a blurred or tinted area on a transparent label, until it is viewed under particular viewing conditions against a dark background. Transparent labels with semi-transparent optical variable features can be applied over other product information, e.g., as an adhesive label on top of product information, because the legibility of the product information beneath the adhesive label is not strongly affected due to the semi-transparent properties of the optically variable feature. Likewise, it may be desirable that anti-counterfeit labels are not readily visible, unless or until they are inspected by authorised personnel.

However, the optical variable feature itself cannot easily be inspected because the product information beneath does not provide a suitable background contrast. This background contrast may be unsuitable for a variety of reasons, for instance because it is not dark enough, or not homogeneous enough, to avow the optical variable feature to be inspected.

Thus, the application of semi-transparent optically variable features was hitherto limited. Known holographic stickers comprise a metallic, silver-tone background to provide the contrast that is necessary for visual inspection of a hologram. Surprisingly, the present invention improves the utility of semi-transparent or near-transparent optically variable devices, because the contrast agent avoids the need to consider the contrast of the surface to which the devices is to be applied. In other words, the contrast of the optically variable feature can be enhanced by embodiments of the present invention, and in particular, can be temporarily and/or reversibly enhanced.

In an embodiment, the contrast agent is provided at one side of the support layer.

It is understood that the support layer is generally planar and has a first surface and a second side opposite the first surface. It will be understood that one of the surfaces is a surface from which the one or more markings are intended to be viewed, and the other of the surfaces is intended to be applied onto a product.

Thus, it will be understood that the contrast agent is ideally provided, with reference to the general viewing direction from which the marking is intended to be viewed, beneath the one or more markings, so as to provide a suitable background contrast. This is the case whether the contrast agent is integral with the support layer, or applied as a separate layer. The contrast agent may be provided in the form of a lacquer, or a varnish, containing the contrast agent. The lacquer or varnish can then be used to coat the support layer.

In an embodiment, the identification device further comprises an adhesive layer or a carrier.

Conveniently, the identification device is provided in the form of a sticker or a sticky label, and the adhesive layer allows the identification device to be applied to a surface without the need for additional equipment. This increases the utility of the identification device.

In an embodiment, the contrast agent is provided with the adhesive layer or with a carrier.

The contrast agent may be integral with, i.e. contained within, the adhesive layer. For instance, the contrast agent may be mixed into the adhesive layer during manufacture of the adhesive. The contrast agent may be applied to one surface of the adhesive layer. This allows the manufacture of the support layer and the contrast agent to be separated.

The support layer may be a transparent layer comprising a semi-transparent optically variable feature. The identification device may be manufactured by applying a photochromic adhesive to one surface of the support layer. Likewise, the identification device may be manufactured by attaching a carrier having a photochromic surface to the support layer. The photochromic surface of the carrier may face towards the support layer, so as to be in direct contact with the support layer. Also, the photochromic surface of the carrier may face away from the support layer.

In accordance with a second aspect of the present invention, there is provided a method of manufacturing an identification device in accordance with the first aspect, the method comprising the steps of providing a support layer comprising one or more markings, providing a contrast agent that is transformable upon application or removal of a non-visible radiation between a first optical state that provides a low contrast with said markings and a second optical state that provides a high contrast with said markings, and applying the contrast agent to the support layer.

In embodiments of the second aspect, the expression “applying” may mean to incorporate, or to bring into physical contact.

### DESCRIPTION OF THE FIGURES

Embodiments of the invention will now be described with reference to the Figures, in which:

FIG. 1 is a partial, cross-sectional side view of a precursor for a photochromic adhesive between two removable release liners;

FIG. 2 is a partial, cross-sectional side view of a cured photochromic adhesive;

FIG. 3 is a partial, cross-sectional side view of an identification device in accordance with the invention;

FIG. 4 is another partial, cross-sectional side view of an identification device in accordance with the invention;

FIG. 5 is a plan view of an identification device in accordance with the invention; and

FIG. 6 is another plan view of an identification device in accordance with the invention.

### DESCRIPTION

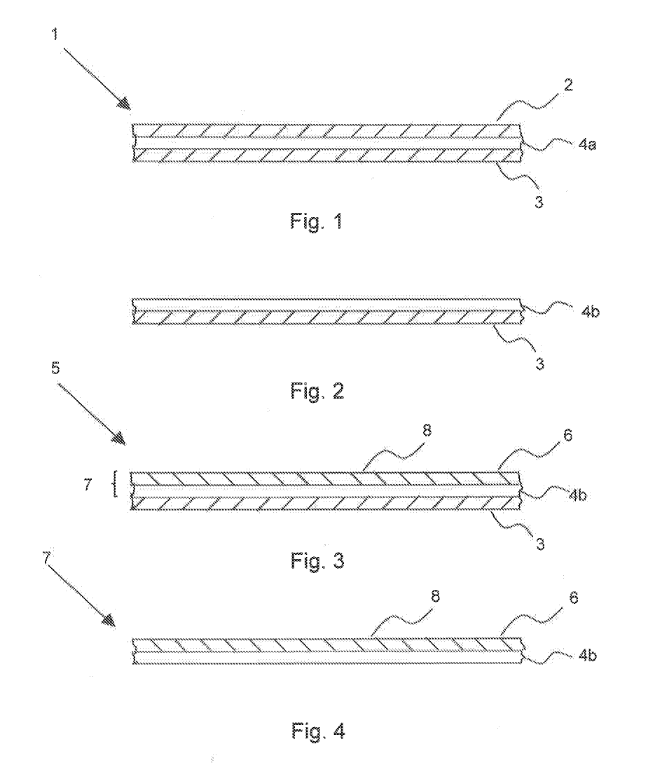

FIG. 1 shows a cross-sectional side view of part of an arrangement 1 that is used to prepare a photochromic adhesive 4b (shown in FIGS. 2 and 3), wherein the photochromic dyes within the adhesive provide the contrast agent of the invention. For the purposes of manufacturing the photochromic adhesive 4b, two removable release liners 2 and 3 are provided. The removable release liners 2 and 3 facilitate the manufacture of a photochromic adhesive, because this may initially be in in the form of a liquid precursor 4a.

The components making up the liquid precursor 4a, including precursors for an adhesive and one or more photochromic dyes, can be admixed before they are applied between the removable release liners. Suitable precursors for adhesives are known in the art, such as, for example, organic solvents combined with acrylic copolymers, but other precursors will be apparent to the skilled person.

The distance between the removable release liner 2 and the removable release liner 3 determines the thickness of the adhesive layer of the photochromic adhesive 4. In an embodiment, the thickness of the adhesive layer of the photochromic adhesive 4b is substantially 1 micrometre. Other thicknesses may be used.

After the liquid precursor 4a has been applied between the removable release liner 2 and the removable release liner 3, and the thickness between the removable release liners has been set to a predetermined distance, the liquid precursor 4a is cured. The curing process solidifies the liquid precursor 4a to form the photochromic adhesive 4b.

The curing process may be carried out using known curing methods, including ultraviolet irradiation, thermal evaporation, natural evaporation, or combinations thereof. The photochromic adhesive 4b is cured when it is sufficiently gelated, or solid, for further handling.

As shown in FIG. 2, the removable release liner 2 has been removed, exposing a surface of the photochromic adhesive 4b.

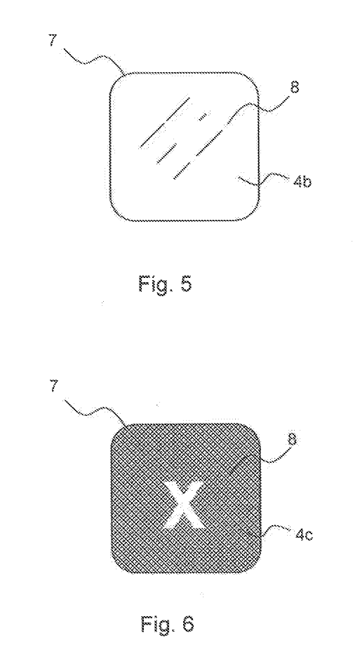

Turning to FIG. 3, an arrangement 5 is shown in which a support layer 6 is glued to the surface of the photochromic adhesive 4b of FIG. 2. The support layer 6 comprises a marking 8 (also shown in the plan view of FIGS. 5 and 6) in the form of an optically variable feature.

As can be seen, the support layer 6, in combination with the photochromic adhesive 4b, forms a label 7 constituting an identification device in accordance with an embodiment of the invention. The removable release liner 3 may remain attached to the label 7 to provide a protective layer for the adhesive layer 4b.

It will be understood that the support layer 6 and or the photochromic adhesive 4b may be cut to size before, during, or after manufacture of the label 7.

In FIG. 4, the removable release liner 3 has been removed, exposing a surface (as shown in FIG. 4, the underside) of the adhesive layer 4b. Thus, the label 7 is in a condition in which it can be applied to a product.

FIG. 5 shows a plan view of a label 7 constituting an identification device of the present invention. As shown in FIG. 5, the label 7 has been cut to size, and has a generally square format with rounded edges. The label may have a size of about 2 cm×2 cm, but other formats may be used.

In FIG. 5, an optically variable feature is indicated in the form of the marking 8. Also indicated in FIG. 5 is the photochromic adhesive 4b, but it will be appreciated that the adhesive layer of the photochromic adhesive 4b is beneath the marking 8.

As shown in FIG. 5, the photochromic adhesive is in a transparent, low-contrast condition, and so it is not readily discernible what the marking 8 is intended to show. As indicated by three hatched lines in FIG. 5, the marking 8 is semi-transparent and it can thus be made out that a marking 8 is present.

In FIG. 6, the photochromic dye in the photochromic adhesive 4b has been activated by ultraviolet irradiation. Due to the ultraviolet radiation, the photochromic adhesive is in a condition 4c, exhibiting a high contrast. The high contrast is indicated in FIG. 6 by the dark pattern of the label 7, but it is appreciate that in practice, the high contrast state could be provided, for instance, by a white opaque tone of colour.

Due to the high contrast, the marking 8, indicated in FIG. 6 by a white ‘X’, is better visible than in FIG. 5. The photochromic dye in the photochromic adhesive of the label 7 remains in a high-contrast state for a limited time, such as 45 seconds. This is long enough to inspect the detail of the marking 8. After the limited time of, e.g., 45 seconds, the photochromic dye will return to a low-contrast condition as indication in FIG. 5. In other words, the contrast of the identification device is temporarily enhanced.

It will be appreciated that the contrast agent need not be comprised in the adhesive layer. For instance, the contrast agent may be provided integral with the support layer, or on a carrier attached to the support layer.

The label in accordance with the invention is unobtrusive and, due to the contrast agent, allows the legibility and/or discernibility of one or more markings to be improved.

Thus, the tradeoff between providing an unobtrusive yet legible label is mitigated by the present invention.

1. An identification device comprising a support layer comprising one or more markings and a contrast agent transformable upon application or removal of non-visible radiation between a first optical state that provides a low contrast with said markings and a second optical state that provides a high contrast with said markings.

2. The identification device in accordance with claim 1, wherein the support layer is at least partially transparent.

3. The identification device in accordance with claims 1 or claim 2, wherein the contrast agent is a photochromic substance.

4. The identification device in accordance with any one of the preceding claims, the contrast agent is responsive to ultraviolet (UV) light, such that UV light causes the transition between the low-contrast state and the high-contrast state.

5. The identification device in accordance with any one of the preceding claims, wherein the contrast agent is configured to allow a reversible transformation between the first optical state and the second optical state.

6. The identification device in accordance with any one of the preceding claims, wherein the contrast agent is configured to allow a repeated reversible transformation between the first optical state and the second optical state.

7. The identification device in accordance with any one of the preceding claims, comprising a plurality of contrast agents including a first contrast agent and a second contrast agent, wherein the first contrast agent exhibits a different response behaviour to the contrast-changing radiation than the second contrast agent.

8. The identification device in accordance with claim 7, wherein at least one of the one or more markings comprises a contrast agent.

9. The identification device in accordance with any one of the preceding claims, wherein the one or more markings comprise an optical machine-readable pattern.

10. The identification device in accordance with any one of the preceding claims, wherein the one or more markings comprise an optically variable feature.

11. The identification device in accordance with any one of the preceding claims, wherein the one or more markings comprise one or more of a security feature or an anti-counterfeit feature.

12. The identification device in accordance with any one of the preceding claims, wherein the contrast agent is provided at one side of the support layer.

13. The identification device in accordance with any one of the preceding claims, further comprising an adhesive layer or a carrier.

14. The identification device in accordance with claim 13, wherein the contrast agent is provided with, within, or on the adhesive layer or with a carrier.

15. A method of manufacturing an identification device in accordance any one of the preceding claims, the method comprising:
providing a support layer comprising one or more markings,
providing a contrast agent that is transformable upon application or removal of a non-visible radiation between a first optical state that provides a low contrast with said markings and a second optical state that provides a high contrast with said markings, and
applying the contrast agent to the support layer.

16. An identification device substantially as hereinbefore described with reference to the Figures.

17. A method of providing an identification device substantially as hereinbefore described with reference to the Figures.
